(19) United States
(12) Patent Application Publication
(10) Pub. No.: US 2010/0012478 A1
(43) Pub. Date: Jan. 21, 2010

(54) THERMAL TREATMENT FOR INORGANIC MATERIALS

(75) Inventors: TOSHITAKA NAKAMURA, OCEANSIDE, CA (US); RAJESH MUKHERJEE, IRVINE, CA (US); BIN ZHANG, VISTA, CA (US); AMANE MOCHIZUKI, SAN DIEGO, CA (US)

Correspondence Address: KNOBBE MARTENS OLSON & BEAR LLP, 2040 MAIN STREET, FOURTEENTH FLOOR, IRVINE, CA, 92614, US

(73) Assignee: NITTO DENKO CORPORATION, OSAKA (JP)

(21) Appl. No.: 12/175,389

(22) Filed: Jul. 17, 2008

(51) Int. Cl. B01J 19/12

(52) U.S. Cl. 204/157.43

(57) ABSTRACT

A method of annealing inorganic particles using microwave is provided. The method comprises disposing a plurality of raw particles having poor room-temperature microwave coupling characteristics in a close proximity to a microwave-absorbing material, irradiating said microwave-absorbing material with microwave radiation to heat said microwave-absorbing material, and heating said plurality of raw particles for a period of time sufficient to obtain a plurality of annealed particles, wherein the plurality of annealed particles has a crystalline phase, and wherein said heating comprises transferring heat from said microwave-absorbing material to said plurality of raw particles.

### BACKGROUND

1. Field of the Invention

The present invention relates to methods of thermal treatment for producing nano-scale materials. In particular, microwave thermal annealing of inorganic materials that are transparent to microwave radiation is disclosed.

2. Description of the Related Art

Inorganic phosphor materials have been widely used for a variety of applications such as fluorescent lamps, cathode ray tubes (CRTs), plasma display panels (PDPs), field emission displays (FEDs), and light emitting diodes (LEDs). These phosphor materials are conventionally manufactured as powders, with particle sizes of around 1-100 μm, by grinding or milling chunks of bulk crystal. However, the relatively large particle sizes produced by the conventional method present certain limitations to the improvement of device performance. For example, the phosphor layer for PDPs is typically formed using a screen printing technique that employs an ink paste with incorporated phosphor material and an organic binder resin. The viscosity of the paste is difficult to control when the particle size is large. Moreover, large particles are not suitable for the increasingly high resolution images required by current display devices. Small phosphor particles, especially nano-scale or nano-sized particles, may provide a solution to this problem and thereby improve these devices.

Various production methods have been developed for the synthesis of nano-scale phosphor particles. These methods can be roughly classified into two categories: wet chemical routes and gas phase pyrolysis routes. Wet chemical routes include sol-gel processing, hydroxide co-precipitation, homogeneous precipitation, and glycothermal treatment. Gas phase pyrolysis routes include spray pyrolysis, metal evaporation/oxidation, thermal plasma spray pyrolysis, flame spray pyrolysis, laser ablation, ion implantation, physical vapor deposition, and chemical vapor deposition methods.

Nano-scale phosphor powders synthesized by wet chemical routes typically yield amorphous materials or crystalline materials unsuitable for immediate use in above-mentioned applications. Thus, subsequent heat treatment is often employed to obtain the desired crystalline phase. Such heat treatment is usually performed by using a conventional electrical furnace. Because the heat treatment requires high temperatures and a relatively long heating time, the process typically consumes considerable amounts of energy. In some instances, it may even be necessary for these phosphor materials to undergo additional heating processes. To overcome this problem, microwave (MW) heat treatment has been successfully employed, resulting in lower energy consumption and a shorter production period. See U.S. Pat. Nos. 6,059,936 and 6,905,636.

Nano-scale powders synthesized by gas phase pyrolysis routes sometimes show luminescence without additional heat treatment. This is possibly due to the higher reaction temperature in the gas phase pyrolysis method compared to the crystallization temperatures employed in wet chemical routes. However, heat treatment is still utilized in most cases to obtain particles with good luminescent property, especially for aluminum garnet based (e.g., Y₃Al₅O_{12,} YAG) rare earth doped phosphor materials such as YAG:Ce (see Y. C. Kang et al. “YAG:Ce phosphor particles prepared by ultrasonic spray pyrolysis,” Material Research Bulletin, 35, 789-798 (2000)), YAG:Tb (see K. Y. Jung et al. “Morphology control and luminescent property of Y₃Al₅O₁₂:Tb particles prepared by spray pyrolysis,” Materials Research Bulletin, 40, 2212-2218 (2005)) and YAG:Eu.

However, the use of MW radiation to anneal oxide materials made by gas phase pyrolysis does create various challenges, since these materials do not couple well with MW radiation at temperatures ranging from room temperature up to about 900° C. Unlike the powders formed by wet chemical routes, the powders formed by gas phase pyrolysis routes are substantially free of MW absorptive material due to the much higher reaction temperatures used to make them. Therefore, additional challenges remain for annealing nano-sized inorganic powders that are transparent to the MW radiation.

A method of sintering inorganic particles with MW radiation is disclosed in U.S. Pat. No. 5,321,223. The method employs a carbon coating on the inorganic particles as a microwave absorber. Although the carbon coated particles can be heated using this method, the presence of such additional MW absorptive material creates the potential of introducing impurities into the final nanoparticle material, which may actually result in lower luminance efficiency in case of phosphor material. Also, such coating steps usually increase the production cost. It is therefore advantageous to develop a method for quickly and effectively annealing inorganic powders while minimizing the risk of introducing impurities.

### SUMMARY

One embodiment provides a method of annealing inorganic particles, comprising disposing a plurality of raw particles having poor room-temperature microwave coupling characteristics in a close proximity to a microwave-absorbing material, irradiating said microwave-absorbing material with microwave radiation to heat said microwave-absorbing material, and heating said plurality of raw particles for a period of time sufficient to obtain a plurality of annealed particles, wherein the plurality of annealed particles has a crystalline phase, and wherein said heating comprises transferring heat from said microwave-absorbing material to said plurality of raw particles.

Another embodiment provides A method of producing crystalline particles comprising forming a plurality of raw particles having poor microwave coupling characteristics using gas phase pyrolysis method, disposing the plurality of raw particles in a close proximity to a microwave-absorbing material, heating said microwave-absorbing material using microwave radiation, and heating said plurality of raw particles for a period of time sufficient to obtain a plurality of annealed particles, wherein the plurality of annealed particles has a crystalline phase, and wherein said heating comprises transferring heat from said microwave-absorbing material to said plurality of raw particles.

These embodiments are intended to be within the scope of the invention herein disclosed. These and other embodiments will become readily apparent to those skilled in the art from the following detailed description of the preferred embodiments having reference to the attached figure, the invention not being limited to any particular preferred embodiment(s) disclosed.

### BRIEF DESCRIPTION OF THE DRAWINGS

FIG. 1 shows a reaction vessel used for MW annealing of the raw inorganic particles.

### DETAILED DESCRIPTION OF THE PREFERRED EMBODIMENTS

The disclosed embodiments are useful for sintering or annealing inorganic particles that are transparent or nearly transparent to microwave (MW) radiation. MW transparent or nearly transparent materials include those materials that do not absorb or poorly absorb MW radiation. For example, raw inorganic particles prepared by gas phase pyrolysis methods typically do not couple with about 2.45 GHz MW irradiation at about 0.5-10 kW of power or have poor MW coupling characteristics at about room temperature. The MW coupling characteristics may be assessed by determining the dielectric loss tangent (tan δ or loss tan) of the material. Tan δ has also been described as ε″/ε′. The dielectric constant can be expressed by the complex dielectric constant (ε=ε′−iε″). Materials considered to have poor microwave coupling characteristics include those having a tan δ of less than 0.003, preferably less than 0.001. For example, ε′ for Al₂O₃ is 9.02 and tan δ is 0.00076 at a frequency of 3.6-3.8 GHz, and thus would couple poorly with the MW irradiation.

One embodiment provides a method of annealing or heat treating raw inorganic particles that have poor MW coupling characteristics at about room temperature. Annealing is a heat treatment that causes changes in the properties of a material that remain after the material is cooled. It is a process that typically involves heating the material, maintaining it at a suitable temperature, and then cooling it. Annealing occurs by the diffusion of atoms within a solid material, so that the material progresses towards its equilibrium state. Heat is needed to increase the rate of diffusion by providing the energy needed to break bonds. The movement of atoms has the effect of redistributing and destroying the dislocations and the defects in a solid structure. In some embodiments, annealing may change the crystal phase of raw inorganic particles or transform an amorphous raw material into a crystalline material. In some embodiments, annealing can transform raw inorganic particles into phosphor material that is capable of emitting photo-luminescent light.

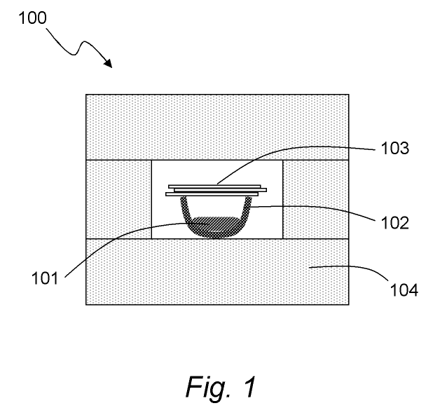

FIG. 1 is a cross-sectional view of one embodiment of the annealing vessel or reactor 100. The annealing vessel or reactor 100 may be placed in a microwave oven or any microwave chamber for the annealing or heating process. The annealing vessel 100 may be made of a refractory ceramic material, such as porous alumina, zirconia, yttria stabilized zirconia, silica, etc. In some embodiments, several porous alumina blocks 104 may be arranged to form an annealing vessel 100.

A plurality of raw inorganic particles 101 or powders to be heated or annealed are disposed inside of the annealing vessel 100, in close proximity to a microwave-absorbing material 103 (i.e., promoter material) that is capable of coupling with the MW irradiation at about room temperature. In some embodiments, the plurality of raw inorganic particles 101 may be placed in a crucible 102 or a secondary container capable of withstanding high temperature annealing process, such as alumina, porcelain or graphite. The crucible 102 or the secondary container is then disposed inside the annealing vessel 100. In some embodiments, the plurality of raw inorganic particles 101 is free flowing and not compacted.

The MW absorbent material 103 is placed in close proximity to the plurality of raw inorganic particles 101 so that heat transfer between the MW absorbent material 103 and the raw inorganic particles 101 may take place. Placing the raw inorganic particles 101 in close proximity to the MW absorbent materials 103 allows the energy absorbed by the MW absorbent material 103 to be radiated, transferring heat from the MW absorbent material 103 to the raw inorganic particles 101 and thereby heating the raw particles 101. Those skilled in the art would recognize that the distance between the MW absorbent material 103 and the raw inorganic particles 101 can vary, depending on various factors. In some embodiments, the distance between the MW absorbing material 103 and the raw inorganic particles 101 may range from about 1 mm to about 5 cm, preferably about 5 mm to about 20 mm, more preferably about 10 mm when using a 1250 W, 2.45 GHz. microwave oven applying about 1 kW of MW radiation for about 15 minutes.

In some embodiments, the MW absorbent material 103 is placed in close proximity to the plurality of raw particles 101 without directly contacting the raw particles 101. In some embodiments, the MW absorbent material 103 may be placed over or next to the crucible 102. In other embodiments, the MW absorbent material 103 is placed in close proximity to the plurality of raw inorganic particles 101 and at least a portion of the raw inorganic particles 101 is not in contact with the MW absorbent material 103. The portion of the raw inorganic particles 101 that are in contact with the MW absorbent material 103 may be discarded if needed or desired. In some embodiments, the percentage of the raw particles 101 that are in contact with the MW absorbent material 103 may be less than 50%, 40%, 30%, 20%, 15%, 10%, 5% or 1% of the plurality of the raw particles 101, by weight based on total weight of the raw particles 101.

In some embodiments, the raw particles 101 can be prepared using a high-temperature and short-residence time pyrolysis process. In other embodiments, the raw particles can be prepared by any gas phase pyrolysis methods. In some embodiments, the gas phase pyrolysis method permits control of the particle size such that the average particle size is less than about 200 nm, or more preferably, less than about 100 nm. In some embodiments, gas phase pyrolysis methods include, but are not limited to, spray pyrolysis, metal evaporation/oxidation, thermal plasma pyrolysis, flame pyrolysis, laser ablation, ion implantation, physical vapor deposition, and chemical vapor deposition methods. Methods and apparatus for producing raw particles are disclosed in copending U.S. patent application Ser. No. 11/131,844, which is hereby incorporated by reference in its entirety and particularly for the purposes of describing such methods and apparatus.

In some embodiments, the raw particles 101 may be converted to a phosphor material during the annealing process. In some embodiments, the annealed particles may be nano-sized phosphor materials. In some embodiments, the annealing process may improve the properties of a phosphor material. Suitable materials for raw particles 101 may be an inorganic host crystal lattice doped with rare-earth elements. In some embodiments, the host crystal lattice may be selected from, but not limited to, metal oxides, metalloid oxides, metal nitrates, and metal oxynitrides.

In some embodiments, the raw inorganic particles 101 as prepared do not necessarily exhibit the desired crystalline phase of the final phosphor materials. For example, if Y₃Al₅O₁₂:Ce is the desired final crystalline phase, raw particles obtained in gas phase pyrolysis may be YAlO₃:Ce, Y₄Al₂O₉:Ce, mixtures of aluminum oxide and yttrium oxide with cerium, or an amorphous phase with cerium. During the annealing process, the raw inorganic particles can be crystallized to garnet structure. Concurrently, Ce atoms can be diffused into garnet crystal and some of Yttirum atoms can be replaced by Ce atoms. The Ce atoms that are incorporated into garnet crystal as a replacement of Yttrium site can be luminescent centers.

A variety of MW absorbent materials 103 can be used, provided that the material have a reasonable dielectric loss factor (ε″) at about room temperature and is durable up to highest attainable temperature for the heat treatment. In some embodiments, preferred MW absorbing materials 103 include, but are not limited to, carbon, silicon, silicon carbide, boron carbide, silicon boride, and titanium nitride. In one embodiment, silicon wafers are used as the promoter material 103, and up to 10 wafers may be stacked over the crucible 102.

When the MW absorbent material 103 is irradiated with the MW radiation, the MW absorbent material 103 couples with the radiation and can be heated very effectively. The heated MW absorbent material 103 then transfers heat to the raw inorganic particles 101 that are placed in a close proximity to the heated MW absorbent material 103. When the temperature of the raw inorganic particles 101 reaches a critical temperature (e.g., approximately 600° C.), the dielectric loss factor of the raw inorganic particles 101 rapidly increases with the rising temperature and exceeds that of the MW absorbent material 103. As a result, the raw inorganic particles 101 then heat up more rapidly and uniformly. The raw inorganic particles 101 are heated or annealed for a period of time sufficient to obtain a plurality of annealed particles. The period of time may be about 5 to about 30 minutes, about 10 to about 30 minutes, about 10 to about 20 minutes, about 12 to about 20 minutes or less than 20 minutes. The plurality of annealed particles may have a crystalline phase desired for various applications. In some embodiments, the plurality of annealed particles has a crystalline phase required for phosphor materials.

In some embodiments, if the raw particles are amorphous powder, these amorphous particles can be converted to crystalline material through MW annealing. In other embodiments, if the starting crystalline phase is tetragonal, cubic crystal may be obtained following the MW annealing. The crystalline phase transition depends on the material system and the phase diagram of the material system. In some embodiments, the annealed particles may have an internal quantum efficiency of at least about 20%, preferably at least about 50%, and more preferably at least about 70% or more. The internal quantum efficiency can be determined as set forth in a copending PCT Application No. PCT/US08/56552, which is hereby incorporated by reference in its entirety, and particularly for the purpose of describing methods of determining internal quantum efficiency.

In some embodiments, the raw inorganic particles 101 may be converted to a phosphor material during the annealing process. In other embodiments, the annealing process may improve the properties of a phosphor material. In some embodiments, the annealed particles may comprise a phosphor material or a plurality of nano-sized phosphor material. In some embodiments, the phosphor material may be a host crystal lattice selected from the group consisting of metal oxides, metalloid oxides, metal nitrates, and metal oxynitrides, doped with rare-earth metal materials.

Since the annealing process is typically done over a relatively short period of time (usually less than 20 minutes), particle aggregation is considerably suppressed. In some embodiments, the annealed particles may be nanoparticles having diameters less than 200 nm or less than about 100 nm. In some embodiments, the particle size may be about 1 to about 200 nm, about 1 to about 100 nm, about 1 to about 50 nm, or about 1 to about 20 nm. In some embodiments, when phosphor powders are annealed, the resulting material provides favorable luminescent properties as a phosphor material.

The optimal temperature range and duration of the annealing treatment depends on the phosphor material to be synthesized. Generally, the phase transition temperature can be determined by differential thermal analysis for each phosphor material. Differential thermal analysis instruments are available commercially. However, the optimal annealing temperature is not necessarily identical to the crystallizing temperature of a host material. The crystallizing temperature and the optimal temperature for the replacement of enough rare-earth atom as an activator is somewhat different. In some embodiment, annealing experiments can first be done by using conventional furnace. A series of phosphor samples may be annealed in different condition by changing the annealing temperature and the annealing duration. These phosphor samples are then characterized by measuring their internal quantum efficiency, and compared to find the optimal condition that result in the one with the highest quantum efficiency. The MW annealing conditions can be adjusted until one of the highest quantum efficiency is obtained.

Since the MW annealing is a rapid thermal annealing, it is usually very difficult to know the exact temperature reached by the phosphor material. Therefore, routine experimentation may be conducted to identify desired annealing time, MW power, MW absorber material and the loading amount.

Thus the present invention can provide highly cost-effective synthesis of nano-scale inorganic particles, such as phosphor materials, without adversely affecting the luminescent properties of the materials.

### EXAMPLE 1

### Preparation of Raw Particles by Using Inductively Coupled RF Thermal Plasma Pyrolysis

0.1485 mol (14.22 g) of yttrium (III) nitrate hexahydrate (99.9% purity, Sigma-Aldrich), 0.25 mol (23.45 g) of aluminum nitrate nonahydrate (99.97% purity, Sigma-Aldrich), and 0.03 mol (0.163 g) of cerium (III) nitrate hexahydrate (99.99% purity, Sigma-Aldrich) were dissolved in 250 ml of deionized water and then ultrasonicated for 30 min to generate a transparent solution. This 0.4 M precursor solution was transferred to a plasma reaction chamber via an atomization probe using a liquid pump.

All deposition experiments were conducted with an RF induction plasma torch (TEKNA Plasma System, Inc PL-35) operating at 3.3 MHz. The chamber pressure was maintained at about 25-35 kPa, and the RF generator plate power was maintained at about 10-12 kW. Both plate power and deposition pressure are user-controlled parameters. Argon was introduced into the plasma torch as both the swirling sheath gas and the central plasma gas via the gas inlet ports. Sheath gas flow was maintained at 30 slm (standard liters per minute), while central gas flow was maintained at 10 slm.

The reactants were injected using a radial atomization probe (TEKNA Plasma System, Inc SDR-772). The probe was positioned at the center of the plasma plume during reactant injection. The reactants were fed into the plasma plume at a rate of 10 ml/min during deposition. Atomization of the liquid reactant was conducted using argon as the atomizing gas, delivered at a flow rate of 15 slm. The cooling water supply for the atomization probe was maintained at a flow rate of 4 slm and at a pressure of 1.2 MPa, as recommended by the manufacturer.

Crystalline phases of the deposited particles were analyzed using X-ray diffraction (XRD) spectroscopy. XRD spectra were obtained with a Bruker AXS micro-diffractometer (CuKα). The crystalline phase of the sample obtained was identified as yttrium aluminum perovskite (YAP). The average particle diameter (Dₐᵥₑ) was obtained from the BET surface area based on data acquired from a Micrometritics model Gemini 2365 gas sorptometer. Dₐᵥₑ of the sample was 75 nm.

### Heat Treatment Using MW Radiation and Characterization

MW heat treatment was conducted as illustrated in FIG. 1. 200 mg of the white nano-scale powder obtained above (YAP crystalline phase) was placed in a boat-shaped alumina crucible without any additional treatment. A silicon wafer about 500 μm thick was used as the MW absorbing material. Ten sheets of silicon wafers were placed onto the alumina boat as shown in FIG. 1. The closest silicon wafer was about 10 mm from the white nano-scale powder. This unit was then placed into a porous alumina brick. The alumina brick was loaded into a commercial MW oven (Panasonic, The Genius 1250 W, 2.45 GHz). 1 kW of MW radiation was applied for 15 minutes, generating a yellow powder.

The crystalline phase of the powder obtained was identified as yttrium aluminum garnet (YAG) by XRD analysis. The internal quantum efficiency (IQE) was determined to be 69.7% using a multi-channel photo detector (Otsuka electronics, model MCPD 7000). Dₐᵥₑ was determined to be 108.3 nm by a BET surface area measurement.

### COMPARATIVE EXAMPLE 1

The raw powder prepared by inductively coupled RF thermal plasma pyrolysis was treated at 1200° C. in H₂/N₂ (3/97) ambient for 2 hours using a quartz tube furnace (MTI Corporation GSL-1600X) at 1 atm. The temperature was increased at a rate of 10° C./min. A yellow powder was obtained for each sample. The IQE was determined to be 69.2% and Dₐᵥₑ was 119.2 nm.

A comparison of Examples 1 and Comparative Example 1 demonstrates that thermal treatment methods of the present invention can generate the same level of IQE and smaller Dₐᵥₑ (which implies that there is less particle aggregation), which leads to energy savings and a considerable reduction in processing time and costs.

What is claimed is:

1. A method of annealing inorganic particles comprising:
disposing a plurality of raw inorganic particles in close proximity to a microwave-absorbing material, wherein the raw inorganic particles have poor microwave coupling characteristics at about room temperature and wherein at least a portion of the plurality of raw inorganic particles is not in contact with the microwave-absorbing material; and
irradiating said microwave-absorbing material with microwave radiation for a period of time that is effective to anneal at least a subportion of the plurality of raw inorganic particles that is not in contact with the microwave-absorbing material, thereby forming a plurality of annealed inorganic particles.

2. The method of claim 1, further comprising disposing said plurality of raw inorganic particles and said microwave-absorbing material in an annealing vessel, said annealing vessel comprising a refractory ceramic material.

3. The method of claim 1, wherein said plurality of raw inorganic particles is not in contact with said microwave-absorbing material.

4. The method of claim 1, wherein said plurality of raw inorganic particles are the product of a high-temperature and short-residence-time pyrolysis process.

5. The method of claim 4, wherein said high-temperature and short-residence-time pyrolysis process comprises gas phase pyrolysis.

6. The method of claim 1, wherein the plurality of annealed particles comprises a phosphor material.

7. The method of claim 6, wherein the phosphor material comprises a host crystal lattice doped with at least a rare-earth metal element, wherein the host crystal lattice is selected from the group consisting of metal oxides, metalloid oxides, metal nitrates, and metal oxynitrides.

8. The method of claim 6, wherein the phosphor material is yttrium aluminium garnet.

9. The method of claim 6, wherein the phosphor material is yttrium aluminium garnet doped with a rare earth metal.

10. The method of claim 1, wherein the plurality of raw inorganic particles has an average particle size of less than about 200 nm.

11. The method of claim 1, wherein the plurality of raw inorganic particles has an average particle size of less than about 100 nm.

12. The method of claim 1, wherein the period of time is less than 20 minutes.

13. The method of claim 1, wherein the plurality of annealed inorganic particles has an internal quantum efficiency of at least about 50%.

14. A method of annealing inorganic particles comprising:
disposing a plurality of free-flowing raw inorganic particles in close proximity to a microwave-absorbing material, wherein the raw inorganic particles have poor microwave coupling characteristics at about room temperature; and
irradiating said microwave-absorbing material with microwave radiation to thereby anneal said plurality of raw inorganic particles to form a plurality of annealed inorganic particles.

15. A method of producing crystalline particles comprising:
forming a plurality of raw particles having poor microwave coupling characteristics using a gas phase pyrolysis method;
disposing the plurality of raw particles in close proximity to a microwave-absorbing material;
heating said microwave-absorbing material using microwave radiation; and
heating said plurality of raw particles for a period of time sufficient to obtain a plurality of annealed particles, wherein the plurality of annealed particles has a crystalline phase, and wherein said heating comprises transferring heat from said microwave-absorbing material to said plurality of raw particles.

16. The method of claim 15, further comprising disposing said plurality of raw particles and said microwave-absorbing material in an annealing vessel comprising a refractory ceramic material.

17. The method of claim 15, wherein said plurality of raw particles does not contact said microwave-absorbing material.

18. The method of claim 15, wherein the plurality of annealed particles comprises a phosphor material.

19. The method of claim 18, wherein the phosphor material is yttrium aluminium garnet.

20. The method of claim 18, wherein the phosphor material is yttrium aluminium garnet doped with a rare-earth metal.

21. The method of claim 15, wherein the plurality of raw particles has an average particle size of less than about 100 nm.
